(19) United States
(12) Patent Application Publication
(10) Pub. No.: US 2005/0117017 A1
(43) Pub. Date: Jun. 2, 2005

(54) System and method for imaging regions of interest

(76) Inventor: Richard L. Baer, Los Altos, CA (US)

Correspondence Address: AGILENT TECHNOLOGIES, INC.;Legal Department, DL 429, Intellectual Property Administration, P.O. Box 7599, Loveland, CO, 80537-0599, US

(21) Appl. No.: 10/725,175

(22) Filed: Dec. 1, 2003

(51) Int. Cl. H04N 7/18

(52) U.S. Cl. 348/87

(57) ABSTRACT

A camera uses a map to retrieve image data pertaining to two or more region of interest segments (ROI segments) within the field-of-view (FOV) of the camera. The map identifies selected pixels of the image located in the region of interest segments. Image data corresponding to the image can be stored and the image data associated with the selected pixels can be accessed individually. In other embodiments, image data associated with the selected pixels is read off of the image sensor row-by-row or pixel-by-pixel. The camera can be included within an optical inspection system to analyze ROI segments on a target surface by transmitting only the image data associated with the ROI segments from the camera to an image processing system of the optical inspection system.

### BACKGROUND OF THE INVENTION

1. Technical Field of the Invention

The present invention relates generally to imaging systems, and more particularly, to cameras capable of imaging regions of interest within an image.

2. Description of Related Art

A camera is used to capture an image of a scene within the field-of-view (FOV) of the camera. The FOV is determined by the magnification of the camera lens and by the dimensions of the image sensor. Within a particular scene, there may be one or more features that are of interest to the camera operator or the application using the camera. A spatial area within the FOV that outlines a particular relevant feature is known as a region of interest (ROI).

In many image processing applications, the ROI within a scene is smaller than the FOV. Multiple ROI segments may also exist in within the FOV. Under these circumstances, the amount of information that is captured and transmitted by the camera can be significantly greater than the amount of information required by the camera operator or application.

As an example, cameras are widely used in the machine vision industry to inspect solder joints and components on printed circuit boards for quality control purposes. There are potentially thousands of features (ROI segments) on a printed circuit board. Thus, each image captured can contain multiple ROI segments that may be spatially located in noncontinguous areas within the FOV of the camera. In order to inspect each component on the PCB, image data corresponding to not only the particular component, but also to surrounding areas on the PCB, is transferred to an image processing system. The high volume of image data unrelated to the ROI segments that is transmitted from the camera necessarily increases the processing time and the complexity of such image processing systems.

Most cameras that are used in machine vision applications utilize either a charge coupled device (CCD) image sensor or a complementary metal oxide semiconductor (CMOS) image sensor. In a CCD image sensor, image data is accessed sequentially, requiring an entire row of pixels to be read out of the image sensor before a subsequent row of pixels can be accessed. By contrast, CMOS image sensors provide parallel access to image pixels, which enables CMOS image sensors to be programmed to image a single rectangular ROI. However, current CMOS image sensors do not provide the ability to image a single irregular-shaped ROI or multiple ROI segments that are spatially separated with respect to one another in a single image frame. The only way to capture irregular-shaped or multiple ROI segments in a standard CMOS image sensor is to include them in a single large rectangle, which increases the number of unrelated pixels that must be transmitted.

Therefore, what is needed is a camera capable of transmitting only that image data corresponding to two or more region of interest segments constituting a single, irregular-shaped ROI or multiple ROI segments that are spatially separated with respect to one another within the field-of-view of the camera.

### SUMMARY OF THE INVENTION

Embodiments of the present invention provide a camera that is capable of retrieving image data pertaining to two or more region of interest (ROI) segments within the field-of-view (FOV) of the camera. The ROI segments either represent spatially noncontiguous ROI segments or collectively form a spatially contiguous, nonrectangular ROI. An image sensor within the camera includes pixels for capturing the image and producing image data corresponding to the image. A map identifying selected pixels located in the region of interest segments is used to retrieve the image data associated with the selected pixels.

In one embodiment, the image data for the entire field-of-view captured by the image sensor is stored in a memory, and the image data associated with the ROI segments is extracted from the memory using the map. In another embodiment, the image data associated with the ROI segments is read directly off of the image sensor. The image data can be read off row-by-row or pixel-by-pixel. When reading the image data pixel-by-pixel, the timing of a reset operation within the image sensor can be adjusted row-by-row in order to compensate for variations in row processing time caused by performing conversions on less than all the pixels in the row. The appropriate reset times are calculated by analyzing the map.

In a further embodiment, the camera is included within an optical inspection system to analyze ROIs on a target surface. The image data corresponding to only the ROI segments is transmitted from the camera to an image processing system to analyze the ROI segments for inspection purposes.

Advantageously, embodiments of the present invention increase the imaging speed when only a subset of the complete field-of-view is transmitted to the image processing application. Likewise, the image data transfer rate is improved by transmitting only a portion of the image data. In addition, the frame rate can also be increased by reading out only a portion of the image data directly from the image sensor. Furthermore, the invention provides embodiments with other features and advantages in addition to or in lieu of those discussed above. Many of these features and advantages are apparent from the description below with reference to the following drawings.

### BRIEF DESCRIPTION OF THE DRAWINGS

The disclosed invention will be described with reference to the accompanying drawings, which show sample embodiments of the invention and which are incorporated in the specification hereof by reference, wherein:

FIG. 1 is a perspective view of an exemplary imaging system capable of imaging region of interest segments (ROI segments) on a target surface within the field-of-view of a camera, in accordance with embodiments of the present invention;

FIG. 2 is a block diagram illustrating an exemplary optical inspection system that can include the imaging system of FIG. 1, in accordance with embodiments of the present invention;

FIG. 3 is a block diagram illustrating exemplary functionality within a camera for imaging ROI segments, in accordance with embodiments of the present invention;

FIG. 4 is a representative view of exemplary mapping functionality within the camera to select pixels located in the ROI segments, in accordance with embodiments of the present invention;

FIG. 5 is a flow chart illustrating an exemplary process for imaging ROI segments, in accordance with embodiments of the present invention;

FIG. 6 is a block diagram illustrating exemplary functionality for transmitting image data corresponding to only pixels within the ROI segments, in accordance with one embodiment of the present invention;

FIG. 7 is a flow chart illustrating an exemplary process for retrieving the image data corresponding to ROI segments, in accordance with embodiments of the present invention;

FIG. 8 is a block diagram illustrating an exemplary CMOS image sensor capable of selecting image data corresponding to ROI segments row-by-row, in accordance with another embodiment of the present invention;

FIG. 9 is a circuit diagram of a pixel array within a CMOS image sensor;

FIGS. 10A and 10B are representative views of a CMOS pixel array illustrating the selection of rows within the pixel array;

FIG. 11 is a flow chart illustrating an exemplary process for selecting rows located in ROI segments within a CMOS image sensor, in accordance with embodiments of the present invention;

FIG. 12 is a block diagram of an exemplary CCD image sensor capable of selecting image data corresponding to ROI segments row-by-row, in accordance with another embodiment of the present invention;

FIG. 13 is a representative view of a CCD pixel array illustrating the selection of rows within the pixel array;

FIG. 14 is a flow chart illustrating an exemplary process for selecting rows located in ROI segments within a CCD image sensor, in accordance with embodiments of the present invention;

FIG. 15 is a block diagram illustrating an exemplary CMOS image sensor capable of selecting image data corresponding to ROI segments pixel-by-pixel, in accordance with another embodiment of the present invention;

FIG. 16A is a timing diagram illustrating the variance in row conversion time within a pixel array using the selected pixels shown in FIG. 4;

FIG. 16B is a timing diagram illustrating the row exposure periods;

FIG. 17 is a flow chart illustrating an exemplary process for selecting pixels located in ROI segments within a CMOS image sensor, in accordance with embodiments of the present invention;

FIG. 18 illustrates the mapping of an exemplary ROI map to a pixel array to calculate the row reset time when selecting individual pixels;

FIG. 19 is a flow chart illustrating an exemplary process for calculating the row reset time using the ROI map;

FIG. 20 is a block diagram illustrating a CMOS image sensor utilizing a global shutter capable of selecting image data corresponding to ROI segments pixel-by-pixel, in accordance with another embodiment of the present invention;

FIG. 21 is a flow chart illustrating an exemplary process for selecting pixels located in ROI segments within a CMOS image sensor utilizing a global shutter, in accordance with embodiments of the present invention;

FIGS. 22-28 illustrate exemplary ROI mapping configurations.

### DETAILED DESCRIPTION OF EXEMPLARY EMBODIMENTS

The numerous innovative teachings of the present application will be described with particular reference to the exemplary embodiments. However, it should be understood that these embodiments provide only a few examples of the many advantageous uses of the innovative teachings herein. In general, statements made in the specification do not necessarily delimit any of the various claimed inventions. Moreover, some statements may apply to some inventive features, but not to others.

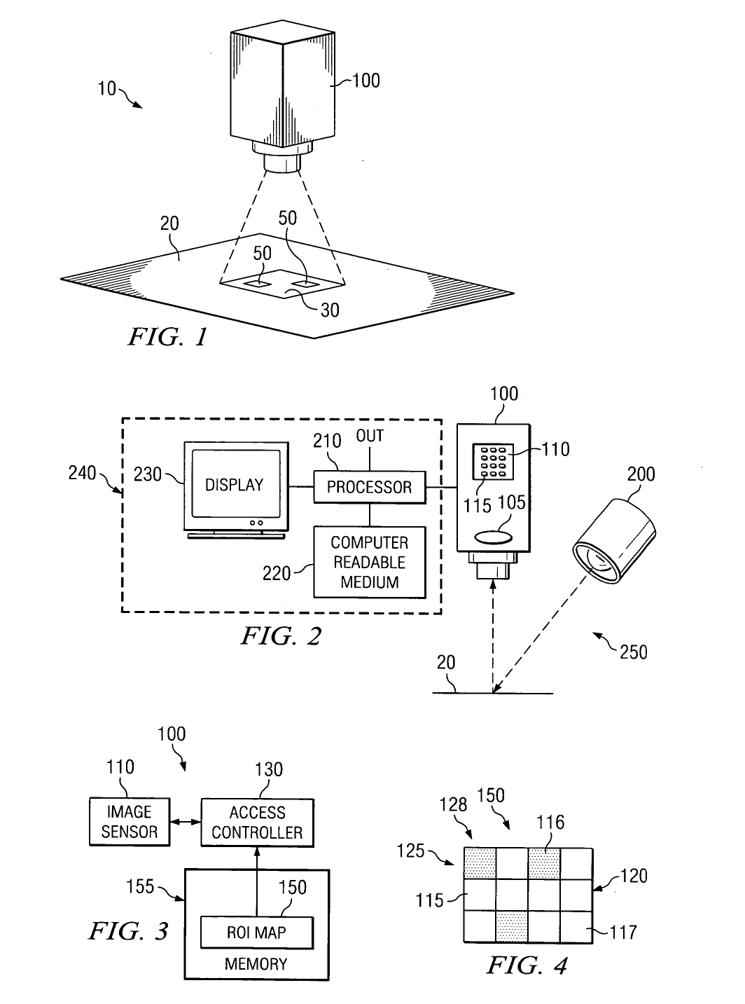

FIG. 1 illustrates a perspective view of a simplified exemplary imaging system 10 capable of imaging two or more region of interest segments (ROI segments) 50 on a target surface 20 within a field of view (FOV) 30 of a camera 100, in accordance with embodiments of the present invention. The target surface 20 can be, for example, a printed circuit board having a multitude of features, such as solder joints and components, thereon. Each image captured can contain multiple ROI segments 50 within the FOV 30 of the camera 100. The multiple ROI segments can either represent spatially noncontiguous ROIs or collectively form a spatially contiguous, nonrectangular ROI. For example, in one embodiment, the ROI segments correspond to individual features on the target surface 20, such that the ROI segments are spatially located in non-contiguous areas on the target surface 20. In another embodiment, the ROI segments 50 correspond to a portion of a feature on the target surface 20. Thus, a particular feature of interest on the target surface 20 can be represented by multiple ROI segments 50 that collectively form a spatially contiguous, complex ROI 50. It should be understood that both contiguous and non-contiguous ROI segments 50 can be within the FOV 30 of the camera 100.

Referring now to FIG. 2, the imaging system 10 of FIG. 1 can be incorporated within an inspection system 250 to inspect features, such as solder joints and components, on a target surface 20 for quality control purposes. The inspection system 250 includes an illumination source 200 for illuminating a portion of the target surface 20 within the field of view (FOV) of the camera 100. The illumination source 50 can be any suitable source of illumination. For example, the illumination source 50 can include one or more light emitting elements, such as one or more point light sources, one or more collimated light sources, one or more illumination arrays, or any other illumination source suitable for use in inspection systems 250. Illumination emitted from the illumination source 50 is reflected by of a portion of the target surface 20 and received by the camera 100. The reflected light (e.g., IR and/or UV) is focused by optics 105 onto an image sensor 110, such as a CMOS sensor chip or a CCD sensor chip within the camera 100. The image sensor 110 includes a two-dimensional array of pixels 115 arranged in rows and columns. The pixels detect the light reflected from the target surface 20 and produce raw image data representing an image of the target surface 20.

The camera 100 is connected to an image processing system 240 to process the raw image data produced by the camera 100. In accordance with embodiments of the present invention, the raw image data transmitted to the image processing system 240 includes only the image data corresponding to the ROI segments on the target surface 20. A processor 210 within the image processing system 240 controls the receipt of the image data and stores the image data in a computer readable medium 220 for later processing and/or display on a display 230. The processor 210 can be a microprocessor, microcontroller, programmable logic array or other type of processing device. The computer readable medium 220 can be any type of memory device, such as a disk drive, random access memory (RAM), read only memory (ROM), compact disc, floppy disc, or tape drive, or other type of storage device. The display 230 can be a two-dimensional display capable of displaying a two-dimensional or three-dimensional image or a three-dimensional display capable of displaying a three-dimensional image, depending on the application. The image can be analyzed by a user viewing the display 230 or the processor 210 can analyze the image data to determine if the feature or features within the image are defective and output the results of the analysis.

The operation of the camera 100 is shown in FIG. 3. To retrieve image data corresponding to only region of interest segments within the image from the image sensor 110, an access controller 130 utilizes an ROI map 150 stored within a memory 155. The ROI map 150 identifies selected pixels within the image sensor 110 corresponding to the region of interest segments. The access controller 130 is operable in response to the ROI map 150 to retrieve the image data associated with the selected pixels. The ROI map 150 can be pre-stored within the camera 100, uploaded to the camera 100 prior to taking an image or programmed into the camera 100 after image capture. In one embodiment, a new ROI map 150 can be used for each new image.

An example of an ROI map is shown in FIG. 4. The ROI map 150 is shown mapped onto a pixel array 120 that includes pixels 115 arranged in rows 125 and columns 128. Each pixel 115 within the pixel array 120 is either a skipped pixel 116 or a selected pixel 117. The selected pixels 117 are located in the region of interest segments within the image. For example, in FIG. 4, in the first row 125, the first pixel is a skipped pixel 116, the second pixel is a selected pixel 117, the third pixel is a skipped pixel 116 and the fourth pixel is a selected pixel 117. Thus, image data from the first row 125 would only be retrieved from the second and fourth pixels 115, corresponding to the selected pixels 117. In the second row 125, all of the pixels are selected pixels 117. Therefore, image data from each of the pixels 115 within the second row 125 would be retrieved. In the third row 125, only the second pixel is a skipped pixel 116, and all other pixels are selected pixels 117. As a result, image data from each pixel 115 except the second pixel (skipped pixel 116) within the third row 125 would be retrieved.

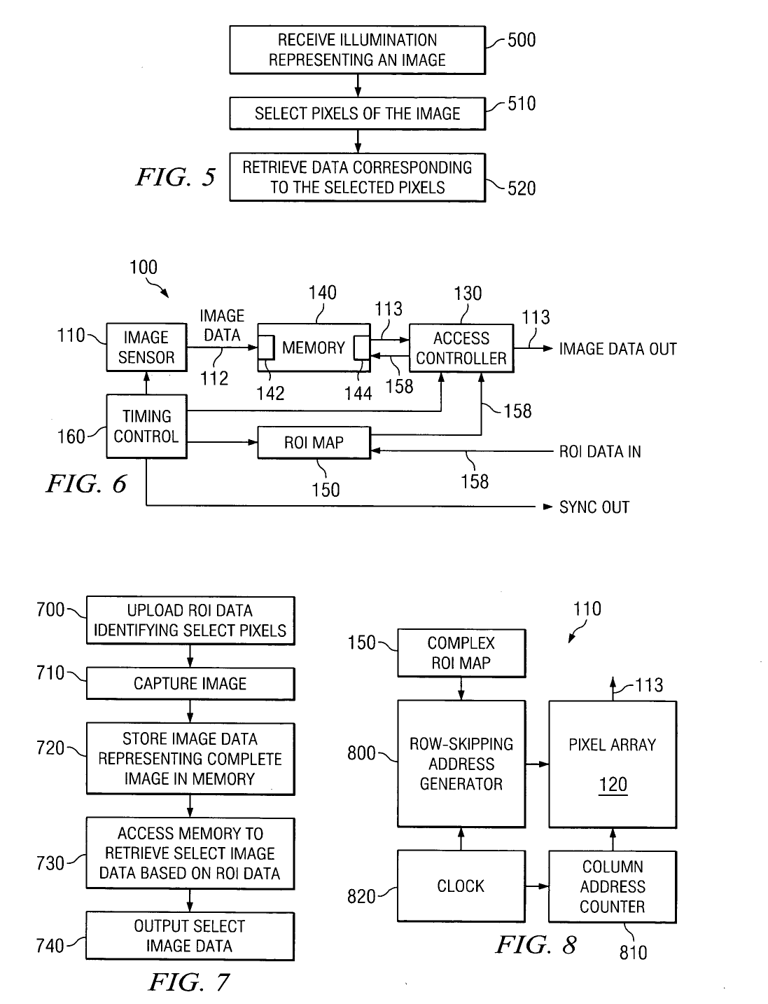

An exemplary process for imaging region of interest segments in accordance with embodiments of the present invention is shown in FIG. 5. To capture an image, the camera receives reflected light from the target surface within the field of view of the camera and focuses the reflected light onto the image sensor (block 500). The region of interest segments on the target surface are mapped to the corresponding pixels on the image sensor to select particular pixels of the image from which image data is to be retrieved (block 510). Once the selected pixels have been identified, the image data from the selected pixels is accessed for subsequent use or processing (block 520).

Depending on the type of image sensor employed, various configurations of the camera can be utilized to retrieve the selected image data corresponding to the multiple, region of interest segments. FIG. 6 illustrates one exemplary configuration of the camera 100 using a conventional image sensor 110 in combination with a two-port frame buffer memory 140. The image sensor 110 can be any type of image sensor, including but not limited to, a CMOS image sensor chip or a CCD image sensor chip. The image sensor 110 captures a complete image of the scene within the FOV of the camera 100 and transmits image data 112 corresponding to the complete image to the memory 140 for storage therein. The image data 112 enters the memory 140 through a first memory port 142. The image data 113 corresponding to the region of interest segments within the image is extracted from a second memory port 144 on the memory 140 by the access controller 130.

The access controller 130 accesses the ROI map 150 to determine the image data 113 to extract. The ROI map 150 includes ROI data 158 that identifies selected pixels of the image sensor 110 located in the region of interest segments within the image. The ROI data 158 can be uploaded into the ROI map 150 on a per image basis, or pre-stored in the ROI map 150 for multiple images. The access controller 130 retrieves the ROI data 158 and uses the ROI data 158 to extract the image data 113 corresponding to the selected pixels within the ROI data 158. Timing control circuitry 160 controls the operation of the image sensor 110, access controller 130 and uploading of ROI data 158 into the ROI map 150 to ensure proper timing of both image capture by the image sensor 110 and image data 113 retrieval by the access controller 130.

An exemplary process for retrieving the image data corresponding to ROI segments is shown in FIG. 7. In order to determine the image data to extract, the ROI data identifying the selected pixels located in the region of interest segments within the image is loaded into the camera (block 700). The ROI data can be uploaded at any point prior to image capture or can be programmed into the camera after image capture. Once the image is captured by the camera (block 710), image data representing the complete image is stored in memory within the camera (block 720). Using the ROI data, the image data corresponding to the selected pixels is retrieved from the memory (block 730), and output for subsequent image processing and/or display (block 740).

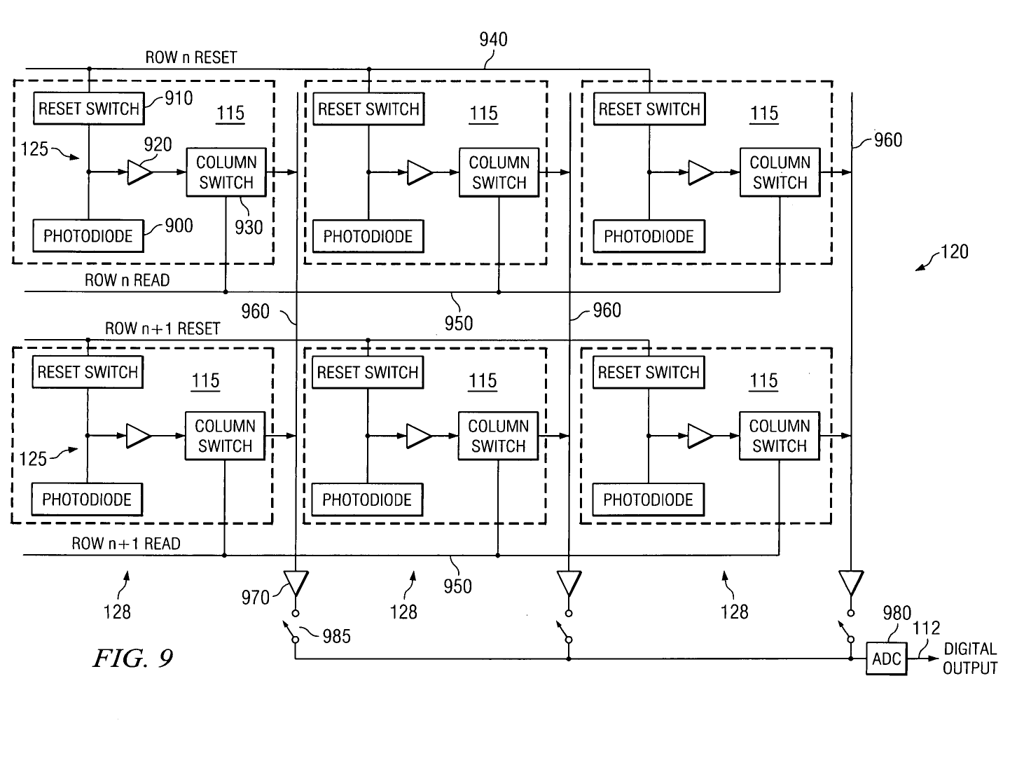

FIG. 8 illustrates another exemplary configuration of the camera 100 using a CMOS image sensor 110 to select image data corresponding to ROI segments row-by-row. The image sensor 110 includes a pixel array 120 for capturing image data corresponding to an image of the scene within the FOV of the camera. The image data is read out of the pixel array 120 using a row address generator 800 that resets and reads image data out of each row of pixels and a column address counter 810 that reads out the image data from each row column-by-column, as described in more detail below in connection with FIG. 9. The row address generator 900 and column address counter 810 function as the access controller 130 of FIG. 6. A clock 820 controls the timing of the row address generator 800 and column address counter 810.

In FIG. 8, the row address generator 800 is a row-skipping address generator capable of skipping one or more rows of pixels within the pixel array 120. Thus, the ROI data within the ROI map 150 is organized row-by-row, such that an entire row of pixels is either selected (within one of the ROI segments) or skipped (outside of the ROI segments). The row-skipping address generator 800 accesses the ROI map 150 to determine which rows of pixels are located in the ROI segments, and therefore, which rows of pixels to reset and read. The column address counter 810 reads out only that image data 113 corresponding to the selected rows.

To more fully understand the operation of a CMOS image sensor, reference is made to the exemplary CMOS pixel array 120 shown in FIG. 9. In FIG. 9, the pixels 115 are shown arranged in rows 125 and columns 128, and each pixel 115 is represented by a photodiode 900, a reset switch 910, an amplifier 920 and a column switch 930. In a CMOS image sensor, operations are traditionally performed on complete rows 125 of pixels 115. Thus, when capturing an image, reset signals and read signals are provided to the pixels on a row-by-row 125 basis. A reset signal applied to a particular row 125 on a reset line 940 releases reset switches 910 connected to each of the photodiodes 900 within the row 125 to reset the potentials of each of the photodiodes 900 to the power supply voltage. After the photodiodes 900 have accumulated charge, a read signal is applied to the row 125 on a read line 950 to release column switches 930 connected to each of the photodiodes 900 within the row 125. For a given row 125 of pixels 115, the interval between the instant that the reset switch 910 is released and the instant that the column switch 930 is released is the exposure period.

When released, the column switches 930 provide the photodiode voltages from each pixel within the row to respective convert lines 960. The photodiode voltages are amplified by a set of column amplifiers 970 connected on convert lines 960 and provided to a smaller set of analog to digital converters (ADC) 980 to transform the analog column signals to digital signals corresponding to the image data 112. The outputs from the pixels 115 within a row 125 are sequentially provided to the ADC 980 by switches 985. The time required by the ADC 980 to digitize the outputs of all of the pixels 115 in a single row 125 is referred to as the row period.

The reset and read lines 940 and 950, respectively, for each row 125 are controlled by a CMOS row address generator (800, shown in FIG. 8) and the convert line 960 (controlled by switch 985) for column 128 is controlled by a CMOS column address counter (810, shown in FIG. 8). In a conventional camera, the row address generator is implemented with row counters, such as a read counter that points to the particular row being read and a reset counter that points to the particular row being reset. The difference between the read and reset counters determines the exposure period (in row periods).

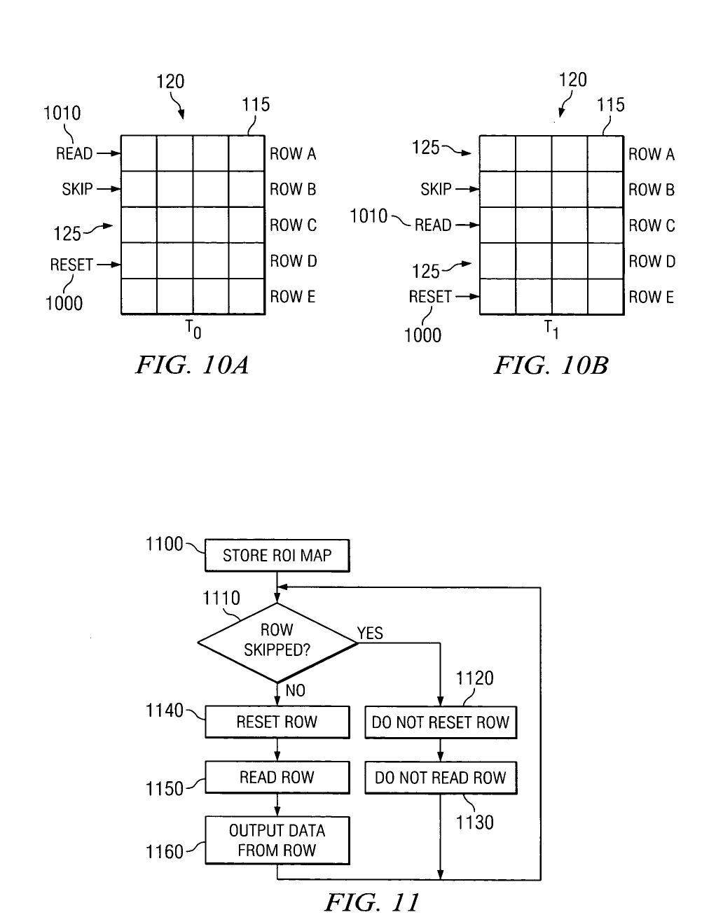

In an exemplary implementation, to output image data only from ROI segments within the FOV of the camera, for each ROI segment, the row counters start on the first row of a particular ROI segment and end on the last row of that particular ROI segment. The row counters skip rows not within a ROI segment, and start again on the first row of the next ROI segment. The row counters are clocked every row period. For example, referring now to FIGS. 10A and 10B, exemplary rows 125 (Rows A-E) of a pixel array 120 are illustrated. In FIG. 10A, at time T₀, the reset counter 1000 is pointing at Row D and the read counter 1010 is pointing at Row A. Thus, at time T₀, Row D is being reset and Row A is being read. Also, as can be seen in FIG. 10A, Row B is labeled “skip,” which indicates that Row B is not within a ROI, and therefore, is skipped by the reset and read counters 1000 and 1010. Therefore, although the reset and read counters 1000 and 1010, respectively, are separated by three rows, the exposure period is only two row periods, since at a previous time (not shown), the reset counter 1000 skipped Row B. This is more easily seen at the next row period shown in FIG. 10B. At the next row period, corresponding to time T₁, the reset counter 1000 has moved down to Row E, while the read counter 1010 has skipped Row B and moved down to Row C. Thus, the exposure period can clearly be seen as corresponding to two row periods in FIG. 10B.

FIG. 11 illustrates an exemplary process for selecting rows located in ROI segments within a CMOS image sensor. Prior to image capture, the ROI data identifying the rows of pixels located in the region of interest segments within the image is loaded into the camera (block 1100). If a particular row of pixels is not included within one of the ROI segments (block 1110), that row of pixels is not reset at the time reset of that row would occur (block 1120). Likewise, the skipped row of pixels is not read at the time reading of that row would occur (block 1130). However, if the row is selected as a part of one of the ROI segments (block 1110), the row is reset and read (blocks 1140 and 1150) in order to output image data from the selected row (block 1160). This process is repeated for each row of pixels (block 1110).

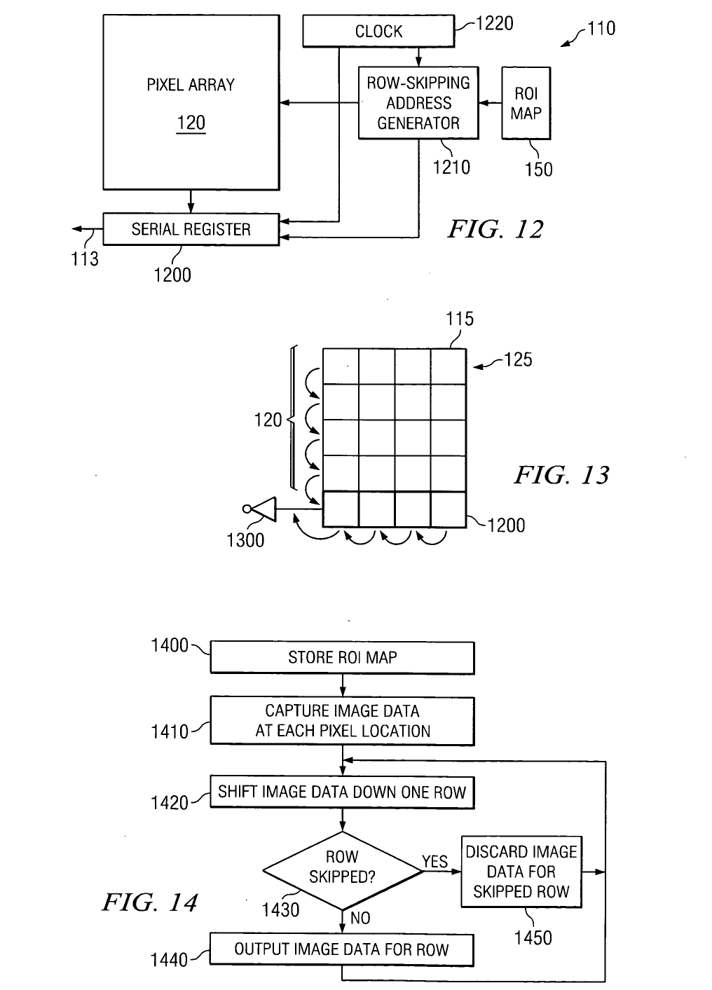

FIG. 12 illustrates another exemplary configuration of the camera 100 using a CCD image sensor 110 to select image data corresponding to ROI segments row-by-row. The CCD image sensor 110 includes a pixel array 120 for capturing image data corresponding to an image of the scene within the FOV of the camera. The image data is read out of the pixel array 120 using a serial register 1200 that outputs image data 113 row-by-row, as described in more detail below in connection with FIG. 13. A row-skipping address generator 1210 is connected to the serial register 1200 to indicate whether the current row should be read or skipped. As in FIG. 8 above, the ROI data within the ROI map 150 is organized row-by-row, such that an entire row of pixels is either selected (within one of the ROI segments) or skipped (outside of the ROI segments). The row-skipping address generator 1210 accesses the ROI map 150 to determine which rows of pixels correspond to the ROI segments, and therefore, which rows of pixels to read out of the serial register 1200. The row-skipping address generator 1210 and serial register 1200 function as the access controller 130 of FIG. 6. A clock 1220 controls the timing of the serial register 1200 and the row-skipping address generator 1210.

Referring now to FIG. 13, an exemplary architecture of a CCD image sensor 110 is illustrated. Within a CCD device, all of the pixels 115 are exposed to light simultaneously to enable each pixel 115 within a CCD pixel array 120 to accumulate charge at the same time. The resulting charges are stored at each pixel site and shifted down in a parallel fashion one row 125 at a time to the serial register 1200. The serial register 1200 shifts the row 125 of charges to an output amplifier 1300 as a serial stream of data. After a row 125 is read out of the serial register 1200, the next row 125 is shifted to the serial register 1200 for readout. The process is repeated until all rows 125 are transferred to the serial register 1200 and out to the amplifier 1300. To output image data only from ROI segments within the FOV of the CCD camera, the serial register 1200 can either output a row 125 of charges to the amplifier 1300 for rows 125 within one of the ROI segments or discard a row 125 of charges for rows 125 not within one of the ROI segments. In one embodiment, a row 125 is discarded by clocking the discarded row 125 without reading the charges out of the serial register 1200. In another embodiment, a row 125 is discarded by clocking the discarded row 125 and quickly shifting the charges out of the serial register 1200.

FIG. 14 illustrates an exemplary process for selecting rows corresponding to ROI segments within a CCD image sensor. Prior to data readout, the ROI data identifying the rows of pixels located in the region of interest segments within the image is loaded into the camera (block 1400). Once the image data representing an entire image is captured by the camera (block 1410), the image data is shifted down on a row-by-row basis to be read out of the CCD sensor (block 1420). If a particular row of pixels is included within one of the ROI segments (block 1430), that row of pixels is read out of the CCD sensor (block 1440) and the rows are shifted down (block 1420). However, if the row is not included in one of the ROI segments (block 1430), the image data for that row is discarded (block 1450) and the rows are shifted down (block 1420).

Although the row-skipping image sensor configurations shown in FIGS. 8-13 can reduce the amount of image data output from the image sensor, these configurations may not significantly reduce the amount of output image data when the ROI segments include multiple rows and only a few pixels within each row. Therefore, in another embodiment, the image sensor can be configured to skip not only rows of pixels, but also individual pixels within each row to allow the ROI segments to be tailored pixel-by-pixel.

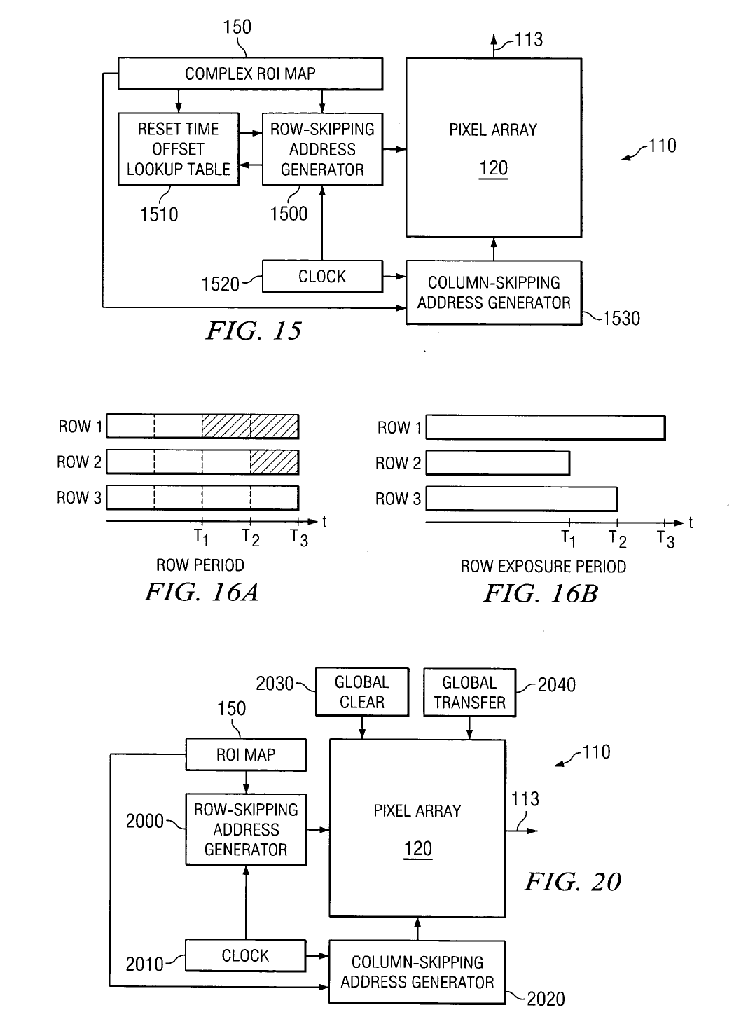

An exemplary CMOS image sensor 110 capable of selecting image data corresponding to ROI segments pixel-by-pixel is shown in FIG. 15. The image sensor 110 includes a pixel array 120 for capturing image data corresponding to an image of the scene within the FOV of the camera. The image sensor 110 further includes a row-skipping address generator 1500 capable of skipping one or more rows of pixels within the pixel array 120, and a column-skipping address generator 1530 capable of skipping one or more individual pixels within each row of pixels. The row-skipping address generator 1500 and column-skipping address generator 1530 function as the access controller 130 of FIG. 6. A clock 1520 controls the timing of the row-skipping address generator 1500 and column-skipping address generator 1530.

The ROI data within the ROI map 150 is organized pixel-by-pixel, such that each individual pixel within the pixel array 120 is either selected (within one of the ROI segments) or skipped (outside of the ROI segments). Thus, the ROI map 150 is accessed by both the row-skipping address generator 1500 and the column-skipping address generator 1530 to determine which individual pixels are located in the ROI segments, and therefore, which individual pixels to reset and read. If an entire row of pixels is not included within any ROI segment, the row-skipping address generator 1500 does not reset or read the skipped row, and therefore, there is no image data for the column-skipping address generator 1530 to read out from the skipped row. However, if any of the pixels within a particular row of pixels is within one of the ROI segments, the row-skipping address generator 1500 resets and reads the entire row of pixels, and the column-skipping address generator 1530 reads out only that image data 113 corresponding to the selected pixels within the row. As an example and referring to the circuit diagram of FIG. 9, in order for the column-skipping address generator 1530 to skip individual pixels within a row, the column-skipping address generator closes only those switches 985 that correspond to the selected pixels 115 in a row 125.

As a result, the number of pixels selected within each row can vary to enable the ROI map 150 to be tailored to any size or shape ROI. Thus, the amount of image data 113 output from the image sensor 110 is reduced to only that image data 113 that is of interest. However, varying the selected pixels on each row alters the row period between rows. The row period can effectively vary between 0 and the maximum time required to convert the image data for a complete row. Since the exposure period is directly proportional to the row period, varying the row period causes the exposure period to vary between rows.

The correlation between the row period and the exposure period is illustrated in FIGS. 16A and 16B. In FIG. 16A, three rows of pixels are shown, with each row having four pixels. In the first row (Row 1), only the first two pixels have been selected. Therefore, the row period for Row 1 is T₁, which corresponds to the time required to convert the voltages from two pixels. In the second row of pixels (Row 2), three pixels have been selected, and the row period for Row 2 is T₂. For the third row (Row 3), all four pixels have been selected, so the row period for Row 3 is T₃.

The resulting exposure periods for Rows 1-3 of FIG. 16A is shown in FIG. 16B. Assuming the reset and read counters are separated by a single row and advance simultaneously when the read process is completed for a row, Row 1 has the longest exposure period and Row 2 has the shortest exposure period. At the time when Row 1 is reset, there is no read operation being performed, so the exposure period is pre-set to the maximum value for the row period (T₃). At the time when Row 2 is reset, Row 1 is being read. At the completion of reading Row 1, the reset and read counters advance to Rows 3 and 2, respectively. Since there are only two pixels to read in Row 1, the exposure time for Row 2 is equivalent to the row period for Row 1 (T₁). At the time when Row 3 is reset, Row 2 is being read. At the completion of reading Row 2, the read counter advances to Row 3, but since there are only three pixels to read in Row 2, the exposure time for Row 3 is equivalent to the row period for Row 2 (T₂). Thus, the time during which the pixels in each row capture light varies between rows. The variable exposure period between rows alters the brightness of the image between rows. As a result, the quality of the image is reduced.

Referring again to FIG. 15, to compensate for variations in row processing time that are caused by performing conversions on a subset of pixels per row, the timing of the reset operation per row can be adjusted using a reset time offset lookup table 1510. In one embodiment, the lookup table 1510 can adjust the timing of the reset switch with the fine granularity of the pixel conversion time rather than the coarse granularity of the row conversion time. The appropriate reset instants populated in the lookup table 1510 are determined by analyzing the ROI map 150.

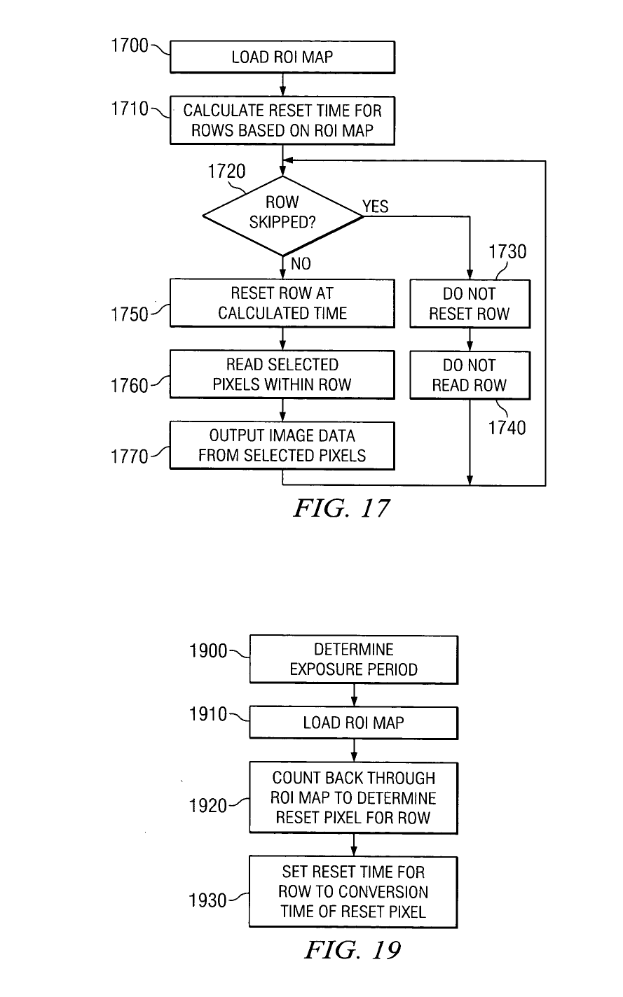

FIG. 17 illustrates an exemplary process for selecting individual pixels located in ROI segments within an image sensor. Before image capture, the ROI data identifying the individual pixels located in the region of interest segments within the image is loaded into the camera (block 1700). From the ROI data, the reset time for each row is calculated to compensate for variable exposure times (block 1710). If a particular row of pixels is not included within one of the ROI segments (block 1720), that row of pixels is not reset at the time reset for that row would occur (block 1730). Likewise, the skipped row of pixels is not read at the time reading for that row would occur (block 1740). However, if any of the pixels within the row is selected as a part of one of the ROI segments (block 1720), the row is reset at the calculated time (block 1750) and image data from the selected pixels within the row is read (block 1760) in order to output image data from the selected pixels within the row (block 1770). This process is repeated for each row of pixels (block 1770).

An example of a row reset calculation method using an ROI map is shown in FIG. 18. The ROI map 150 is shown mapped onto a pixel array 120 including pixels 115 arranged in rows 125 (Rows 1-8) and columns 128. Each pixel within the pixel array 120 is either a skipped pixel 116 or a selected pixel 117. The selected pixels 117 are located in the region of interest segments within the image. As discussed above, the exposure period for a given row 125 begins when the reset signal is sent and ends when the read signal is sent. Therefore, the timing of the reset signal for each row 125 of pixels 115 can be determined from the desired exposure period and the ROI map 150.

In FIG. 18, the reset timing for a given row 125 is determined by counting selected pixels 117 backwards in the ROI map 150 until the value is reached that corresponds to the exposure period measured in individual pixel conversion periods, where an individual pixel conversion period is the time required to convert the analog value of one pixel to a digital value. In the example presented in FIG. 18, the desired exposure period is ten pixel conversion periods. Thus, the reset signal for a row 125 is sent ten pixel conversion periods before the read (column select) signal. For example, the reset signal for Row 5 is issued before the conversion of the second selected pixel 117 in Row 2. As another example, the reset signal for Row 8 is issued before the conversion of the second selected pixel 117 in Row 6.

It should be understood that depending on the exposure period and ROI map, it may be necessary to issue the reset signals for multiple rows during the conversion of a single row. Likewise, it may be unnecessary to issue any reset signals during the conversion of a particular row. The timing of the reset signal is dependent on the contents of the ROI map.

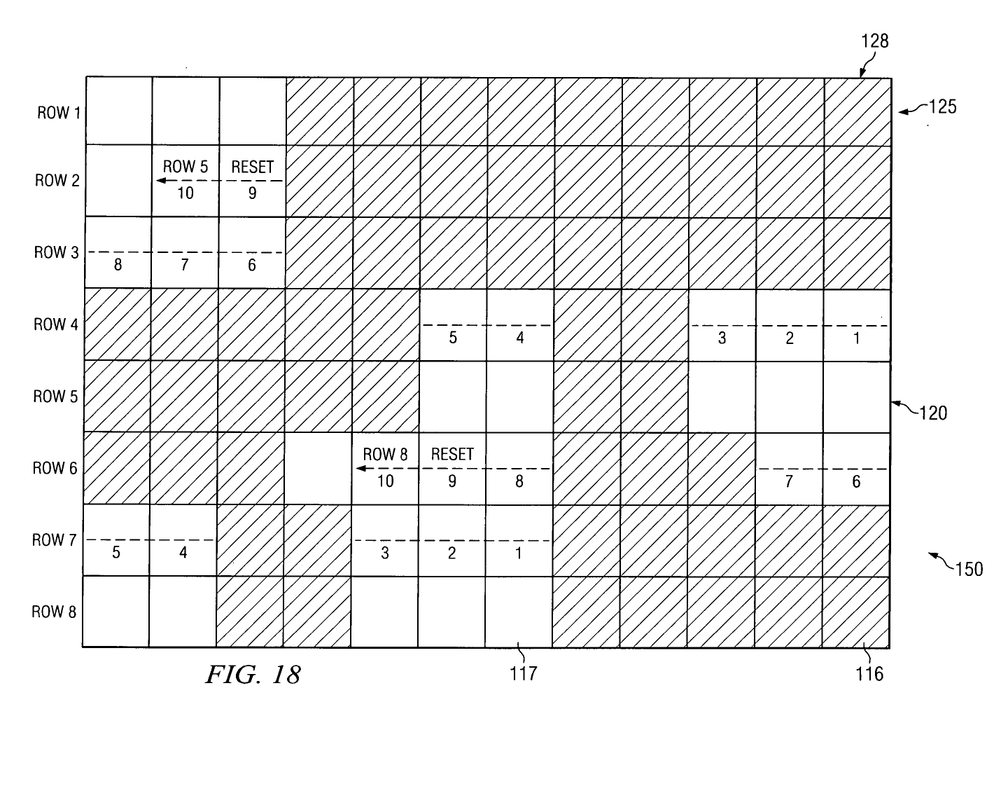

FIG. 19 illustrates an exemplary process for calculating the row reset time using the ROI map. Depending on the image sensor, external lighting, object surface and other factors, the desired exposure period for each individual pixel is calculated prior to taking an image of the object surface (block 1900). Thereafter, the ROI map identifying the selected pixels located in the region of interest segments within the image is loaded into the camera (block 1910). Based on the ROI map and the desired exposure period, the reset timing for each row is calculated by counting the selected pixels back through the ROI map to identify the reset pixel for each row (block 1920). Once the reset pixels for each row are identified, the reset timing for each row is set to the conversion time of the respective reset pixel for each row (block 1930).

FIG. 20 illustrates another exemplary configuration of the camera using a CMOS image sensor utilizing a global shutter capable of selecting image data corresponding to ROI segments pixel-by-pixel. The image sensor 110 includes a pixel array 120 for capturing image data corresponding to an image of the scene within the FOV of the camera. The image sensor 110 further includes a row-skipping address generator 2000 capable of skipping one or more rows of pixels within the pixel array 120, and a column-skipping address generator 2020 capable of skipping one or more individual pixels within each row of pixels. The row-skipping address generator 2000 and column-skipping address generator 2020 function as in the access controller 130 of FIG. 6. With a global shutter, the row-skipping address generator 2000 and column-skipping address generator 2020 perform only read operations. There is no reset operation on a row-by-row basis performed by the row-skipping address generator 2000, as will be described in more detail below. A clock 2010 controls the timing of the row-skipping address generator 2000 and column-skipping address generator 2020.

The ROI data within the ROI map 150 is organized pixel-by-pixel, such that each individual pixel within the pixel array 120 is either selected (within one of the ROI segments) or skipped (outside of the ROI segments). Thus, the ROI map 150 is accessed by both the row-skipping address generator 2000 and the column-skipping address generator 2020 to determine which individual pixels are located in the ROI segments, and therefore, which individual pixels to read. To capture an image, a global clear function 2030 is released to allow all of the pixels within the pixel array 120 to sample the light. After the pixels have accumulated charge, a global transfer function 2040 is released to transfer the charge into an internal memory. Thus, the pixel array 120 includes an analog memory where the representation of the image is stored as a pattern of charge. If an entire row of pixels is not included within any ROI segment, the row-skipping address generator 1000 does not read the skipped row, and therefore, there is no image data for the column-skipping address generator 2020 to read out from the skipped row. However, if any of the pixels within a particular row of pixels is within one of the ROI segments, the row-skipping address generator 2000 reads the entire row of pixels, and the column-skipping address generator 2020 reads out only that image data 113 corresponding to the selected pixels within the row.

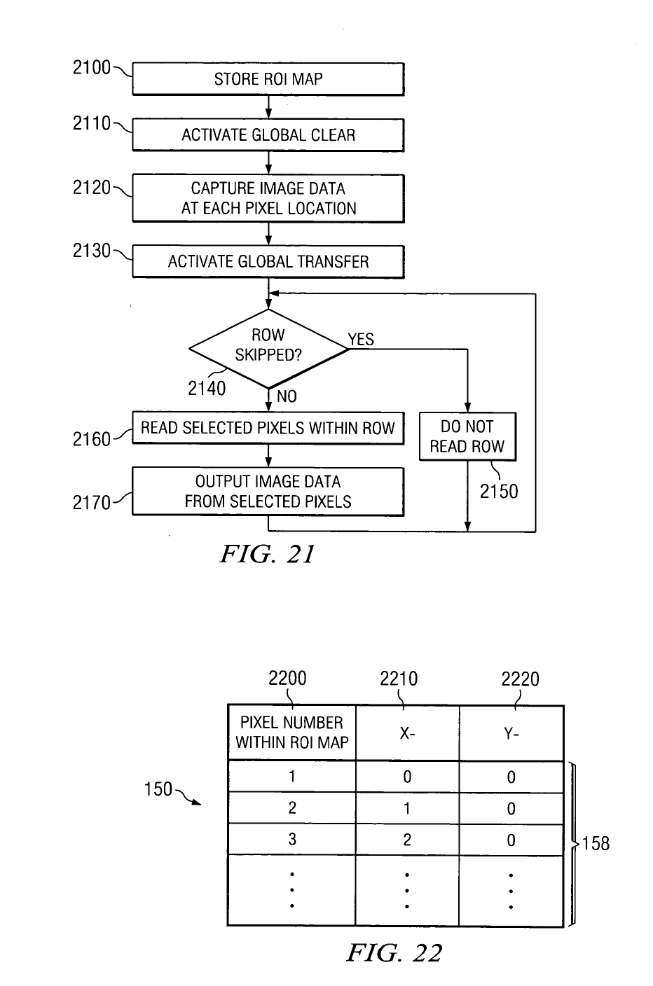

FIG. 21 illustrates an exemplary process for selecting pixels located in ROI segments within a CMOS image sensor utilizing a global shutter. Before image data read out, the ROI data identifying the individual pixels located in the region of interest segments within the image is loaded into the camera (block 2100). A complete image is taken by activating a global clear function (block 2110) to capture image data at each pixel location (block 2120). The image data is stored within the image sensor by activating a global transfer function (block 2130). Thereafter, image data corresponding to only ROI segments is transferred out of the image sensor using the ROI map. For example, if a particular row of pixels is not included within one of the ROI segments (block 2140), that row of pixels is not read (block 2150). However, if any of the pixels within the row is selected as a part of one of the ROI segments (block 2140), the image data from the selected pixels within the row is read (block 2170) in order to output image data from the selected pixels within the row (block 2170). This process is repeated for each row of pixels (block 2140).

It should be understood that the ROI data within the ROI map can be represented in a number of different formats regardless of the camera and image sensor configuration. Examples of ROI data formats are shown in FIGS. 22-28. However, it should be noted that the ROI data is not limited to the formats illustrated in FIGS. 22-28, and can be organized in any format that identifies ROI segments within an image.

One exemplary format for the ROI data is shown in FIG. 22. In FIG. 22, the ROI data 158 within the ROI map 150 includes a list of the coordinates of each pixel included in the ROI segments. The ROI map 150 is illustrated as a table with three columns. In the first column 2200, the pixel number within the ROI map is listed. In the second column 2210, the x-coordinate for the location of that pixel number within the image sensor is listed. In the third column 2220, the y-coordinate for the location of that pixel number within the image sensor is listed. From the coordinate information, entire rows of pixels can be identified as selected or skipped, or individual pixels within each row can be identified as selected or skipped.

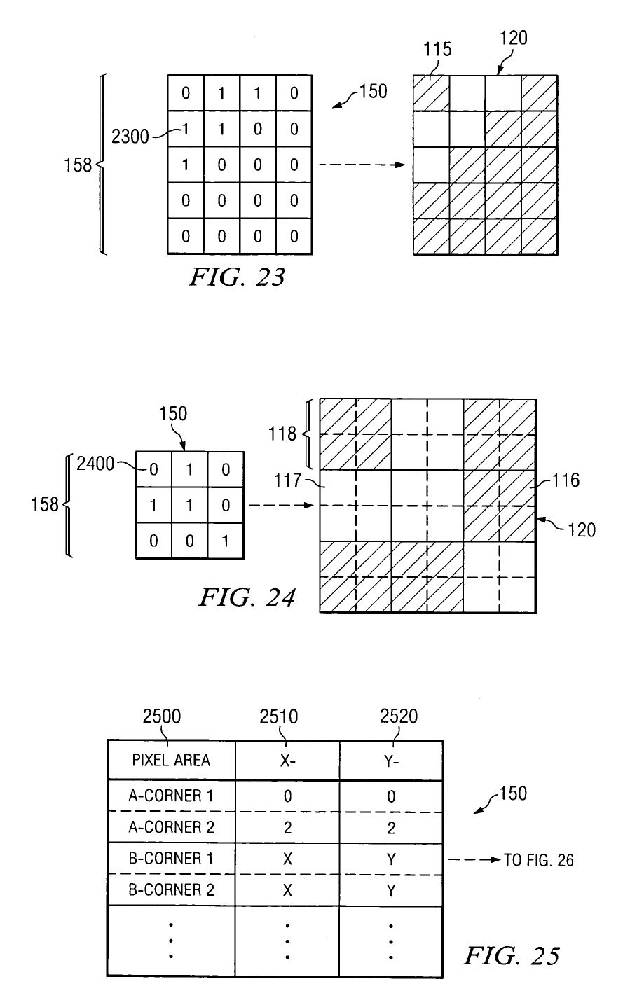

FIG. 23 illustrates another exemplary format for the ROI data 158 within the ROI map 150. In FIG. 23, the ROI data 158 is mapped onto the pixel array 120, and includes a one bit indicator 2300 for each pixel 115 that indicates whether or not the pixel 115 is included in one of the ROI segments. FIG. 24 illustrates yet another exemplary format for the ROI data 158 within the ROI map 150. FIG. 24 utilizes a reduced-resolution map, where each location in the map corresponds not to an individual pixel 115 within the pixel array 120, but rather to a block of pixels 118. Each block of pixels 118 can be an N by N block or an M by N block. Each map location includes a one bit indicator 2400 that indicates whether the block of pixels 118 corresponding to the map location includes selected pixels 117 or skipped pixels 116.

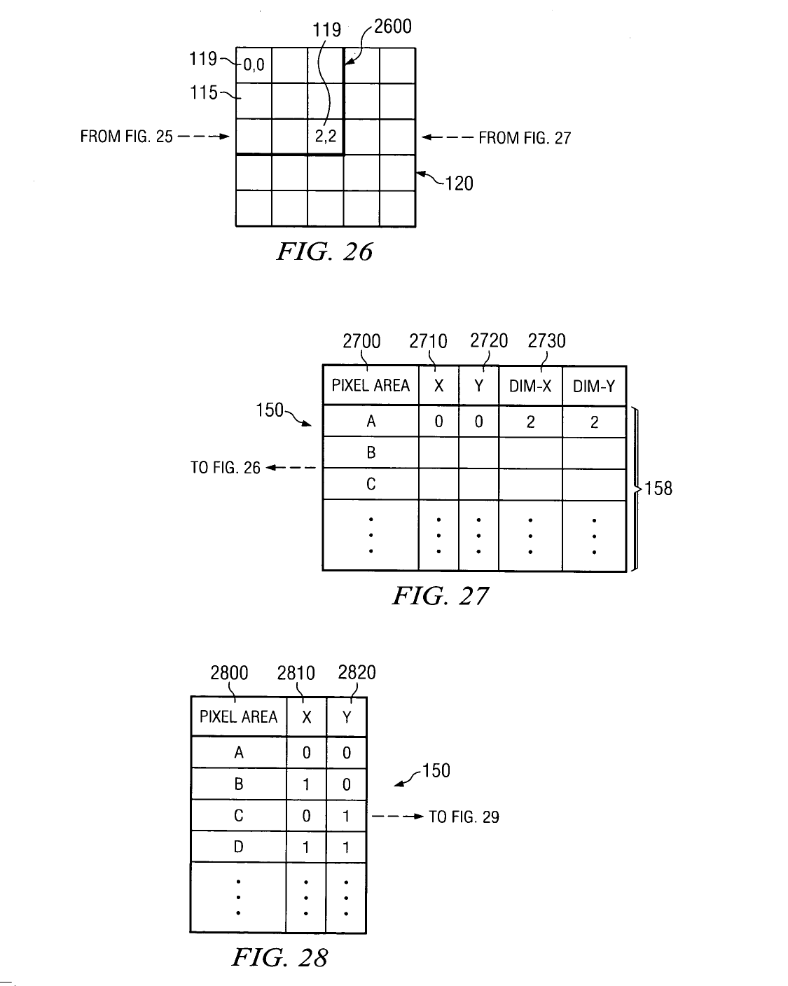

FIG. 25 illustrates another exemplary format for the ROI data 158 within the ROI map 150. In FIG. 25, the ROI data 158 includes a list of the coordinates of two of the corners of each non-overlapping rectangular ROI. Thus, the ROI map 150 in FIG. 25 is a table with three columns. In the first column 2500, the pixel area within the ROI map is listed. In the second column 2510, the x-coordinates of each corner pixel within the image sensor for that ROI are listed. In the third column 2520, the y-coordinates of each corner pixel within the image sensor for that ROI are listed. From the coordinate information, as shown in FIG. 26, the corner pixels 119 for each pixel area 2600 corresponding to an ROI can be identified, and from the corner pixels 119, the entire pixel area 2600 can be determined.

The same pixel area 2600 in FIG. 26 can be identified using other ROI data formats, such as the format shown in FIG. 27. In FIG. 27, the ROI data 158 includes a list of the coordinates of a single corner, and the dimensions of each ROI. Thus, the ROI map 150 in FIG. 27 is a table with five columns. In the first column 2700, the pixel area within the ROI map is listed. In the second column 2710, the x-coordinate of one of the corner pixels 119 (shown in FIG. 26) within the image sensor for that ROI is listed. In the third column 2720, the y-coordinate of that corner pixel 119 within the image sensor for that ROI is listed. In the fourth column 2730, the x-dimension of the pixel area is listed, and in the fifth column 2740, the y-dimension of the pixel area is listed. From the coordinate information and dimension information, as shown in FIG. 26, one of the corner pixels 119 for the pixel area 2600 corresponding to an ROI can be identified, and using the x- and y-dimensions, the entire pixel area 2600 can be determined.

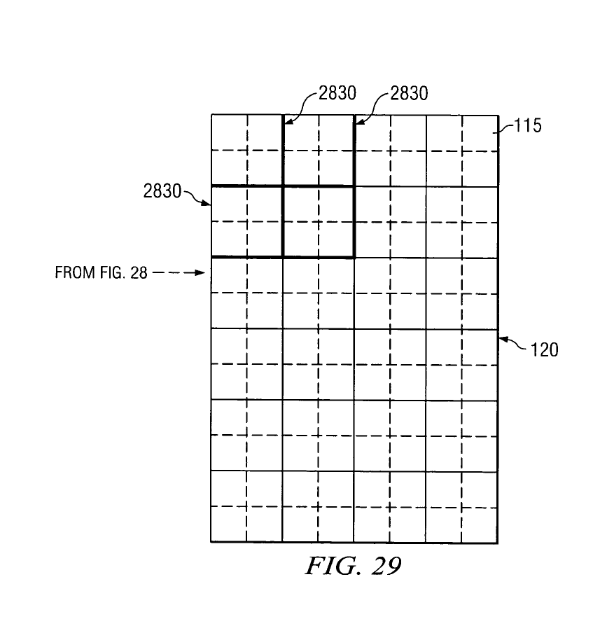

FIG. 28 illustrates another exemplary format for the ROI data 158 within the ROI map 150. In FIG. 28, the ROI data 158 includes a list of coordinates of selected pixels 115 at a reduced resolution, where every coordinate corresponds to an M by N block of pixels 115 (pixel area 2830), shown in FIG. 29. Thus, the ROI map 150 in FIG. 28 is a table with three columns. In the first column 2800, the pixel area 2830 within the ROI map is listed. In the second column 2810, the x-coordinate of M by N block of pixels 115 within the image sensor for that ROI is listed. In the third column 2820, the y-coordinate of the M by N block of pixels 115 within the image sensor for that ROI is listed. From the coordinate information, the M by N block of pixels 115 (pixel area 2830) within the pixel array 120 corresponding to an ROI can be identified.

As will be recognized by those skilled in the art, the innovative concepts described in the present application can be modified and varied over a wide range of applications. Accordingly, the scope of patented subject matter should not be limited to any of the specific exemplary teachings discussed, but is instead defined by the following claims.

1. A camera, comprising:
an image sensor including pixels for capturing an image having two or more region of interest segments and producing image data corresponding to the image;
a memory storing a map identifying selected ones of the pixels located in the region of interest segments within the image; and
an access controller configured to retrieve the image data associated with the selected pixels in response to the map.

2. The camera of claim 1, further comprising:
an additional memory for storing the image data corresponding to the image, said access controller being configured to access said additional memory to retrieve the image data associated with the selected pixels.

3. The camera of claim 1, wherein the plurality of pixels are arranged in rows and columns within a pixel array.

4. The camera of claim 3, wherein said selected pixels are located in one or more selected ones of the rows of the pixels within said pixel array, said access controller being configured to read the image data associated with the selected rows out of said image sensor row-by-row.

5. The camera of claim 4, wherein said image sensor is a complementary metal oxide semiconductor image sensor.

6. The camera of claim 4, wherein said image sensor is a charge coupled device image sensor.

7. The camera of claim 3, wherein said selected pixels correspond to individual ones of the pixels within the pixel array, said access controller being configured to read the image data associated with the selected pixels out of the image sensor pixel-by-pixel.

8. The camera of claim 7, wherein said access controller is further configured to calculate a reset time for each of the rows based on the map to provide a substantially uniform row exposure period throughout the pixel array.

9. The camera of claim 7, wherein said image sensor is a complementary metal oxide semiconductor image sensor.

10. The camera of claim 7, wherein said image sensor is a charge coupled device image sensor utilizing a global shutter.

11. The camera of claim 3, wherein the map includes coordinates of the selected pixels within the pixel array.

12. The camera of claim 3, wherein the map is a bit-wise map of the pixel array.

13. The camera of claim 3, wherein the map is a reduced resolution bit-wise map of the pixel array.

14. The camera of claim 3, wherein the region of interest segments correspond to blocks of pixels each having four corner pixels and the map includes coordinates of two of the corner pixels for each of the blocks of pixels.

15. The camera of claim 3, wherein the region of interest segments correspond to blocks of pixels each having four corner pixels and the map includes coordinates of one of the corner pixels for each of the blocks of pixels and dimensions of each of the blocks of pixels.

16. The camera of claim 3, wherein the region of interest segments correspond to blocks of pixels each having four reduced resolution corner pixels and the map includes coordinates of two of the reduced resolution corner pixels for each of the blocks of pixels.

17. An optical inspection system, comprising:
a camera including an image sensor for capturing an image of a target surface having two or more region of interest segments within the field-of-view of the camera and producing image data corresponding to the image; and
an image processing system connected to the camera to receive and process only the image data associated with the region of interest segments.

18. The optical inspection system of claim 17, wherein said camera further includes:
an image sensor including pixels for capturing the image and producing the image data corresponding to the image;
a memory storing a map identifying selected ones of the pixels located in the region of interest segments within the image; and
an access controller configured to retrieve the image data associated with the selected pixels in response to the map.

19. A method for imaging region of interest segments on a target surface, comprising:
capturing an image containing pixels;
storing a map identifying selected ones of the pixels located in region of interest segments within the image; and
retrieving image data corresponding to the image and associated with the selected pixels using the map.

20. The method of claim 19, wherein said retrieving further comprises:
storing the image data corresponding to the image; and
accessing the image data associated with the selected pixels.

21. The method of claim 19, wherein said retrieving further comprises:
reading the image data associated with the selected pixels row-by-row.

22. The method of claim 19, wherein said retrieving further comprises:
reading the image data associated with the selected pixels pixel-by-pixel.

23. The method of claim 22, further comprising:
calculating a reset time for each row of the plurality of pixels based on the map.

24. The method of claim 19, further comprising:
loading the map into a memory.

25. The method of claim 19, further comprising:
transmitting the image data associated with the selected pixels.
